(19) United States
(12) Patent Application Publication
(10) Pub. No.: US 2002/0107689 A1
(43) Pub. Date: Aug. 8, 2002

(54) Method for voice and speech recognition

(76) Inventor: Meng-Hsien Liu, Taoyuan (TW)

Correspondence Address: J.C. PATENTS, Suite 250, 4 Venture, Irvine, CA, 92618, US

(21) Appl. No.: 09/779,400

(22) Filed: Feb. 8, 2001

(51) Int. Cl. G10L 15/00

(52) U.S. Cl. 704/251

(57) ABSTRACT

A method of voice and speech recognition. The method comprises the steps of inputting a plurality of sectioned pronounced sounds, wherein the sectioned sounds are expressed by characters, single set tune and single set phrase. A plurality of letters respective to the sectioned pronounced sounds are obtained. A plurality of user-defined pronounced sounds is inputted to respectively express a plurality of symbols. The sectioned pronounced sounds and the user-defined pronounced sounds are recognized. The letters are combined to obtain a plurality of possible words and a plurality of switching language mode operations. At least a correct word is chose.

### BACKGROUND OF THE INVENTION

1. Field of Invention

The present invention relates to a method for voice and speech recognition. More particularly, the present invention relates to a method for spelling-voice recognition.

2. Description of Related Art

During this information bomb age, a lot of software products are developed for being easily operated and used. Inputting codes and keying words to control and operate a computer through voice and speech recognition is a very hominized method in nowadays. Typically, the sentences inputted into the information appliance (IA) are few. The conventional voice and speech recognition is based on recognizing the characters of tone and rhyme to distinguish the inputted voice and speech. However, recognition accuracy of the method described above is lower than 100% and it could spends much time to accurately tell the words and the phrases that are hard to be recognized. Therefore, the conventional voice and speech recognition is no more convenience to be used.

FIG. 1 is a flow chart of a conventional method for voice and speech recognition. As shown in FIG. 1, in this type of recognition, voice and speech are inputted through a microphone 102 into a pre-amplifier 104. Thereafter, the inputted voice and speech are converted into digital signals by a digital signal processor 106 and the digital signals are transferred into a system 108 with a processor.

As shown in FIG. 2, a system frame diagram of a conventional method for voice and speech recognition, the method comprises steps of sectioning the inputted voice and speech into sound cases by voice and speech sensor (step 202), running character factor processor (step 204), picking out the appropriate sounds and inputting appropriate sound table by both tune recognition (step 206) and continuant-sound table searching machine (step 208) and determining the possible word subsequently from quickly viewing the sound table by sound-table-searching machine (step 210) and from matching context by choosing phase machine (step 212). Eventually, the determined words are outputted.

Nevertheless, after the serial sentences are recognized, the recognition accuracy is very worse especially for recognizing foreign language such as Mandarin. Taking Mandarin as an example, there are hundred thousands of phrases in Mandarin. Searching for the possible phrases takes a very long time. Besides, the phrase and words resembled in the sounds of the searched word could be a lot. Therefore, the inaccuracy of the recognition result is high and the recognition efficiency is not as well as the anticipation. Moreover, since the phrases are a lot and the same phrases possess plenty of meanings, the auto-correction and auto-learning functions of computer are hard to perform and the recognition inaccuracy is still high.

According to the above description, the conventional method for voice and speech recognition includes the following disadvantages:

1. The continuing sentences are section into several syllables and the tunes and rhythms of the syllables are respectively recognized. At last, voice and speech are determined into words and phase by matching their sound characters, customarily using phrase and contextual continuation. Apparently, the recognition process is very redundancy.

2. The phrases are huge, the meaning of a single word could be a lot and many phases are seldom used so that it is hard to efficiently utilize auto-correction function of the computer.

3. Since it is not easy to section the continuation sentences and it is also hard to tell the tune and the rhythm of each sectioned part of a sentence, the recognition accuracy is still poor although the recognition process is complicated. Furthermore, the auto-correction function of the computer cannot be accurately performed, the recognition accuracy is low.

### SUMMARY OF THE INVENTION

The invention provides a method of voice and speech recognition. The method comprises the steps of inputting a plurality of sectioned pronounced sounds, wherein the sectioned sounds are expressed by characters, single set tune and single set phrase. A plurality of letters respective to the sectioned pronounced sounds are obtained. A plurality of user-defined pronounced sounds is inputted to respectively express a plurality of symbols. The sectioned pronounced sounds and the user-defined pronounced sounds are recognized. The letters are combined to obtain a plurality of possible words and a plurality of switching language mode operations. At least a correct word is chose.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart of a conventional method for voice and speech recognition;

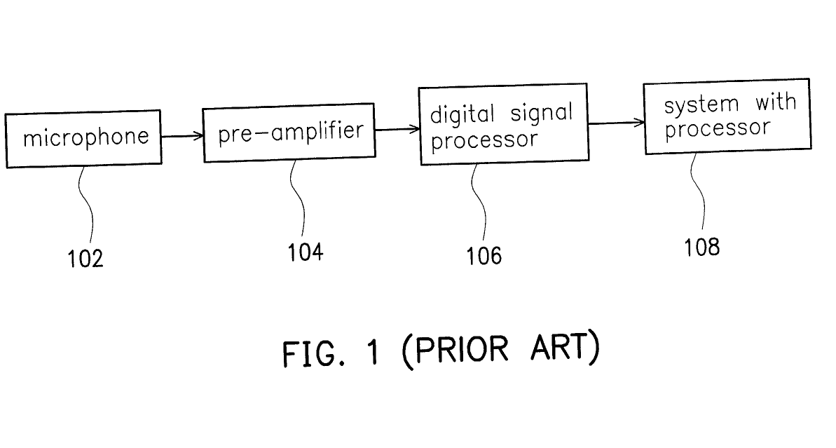

FIG. 2 is a system frame diagram of a conventional method for voice and speech recognition;

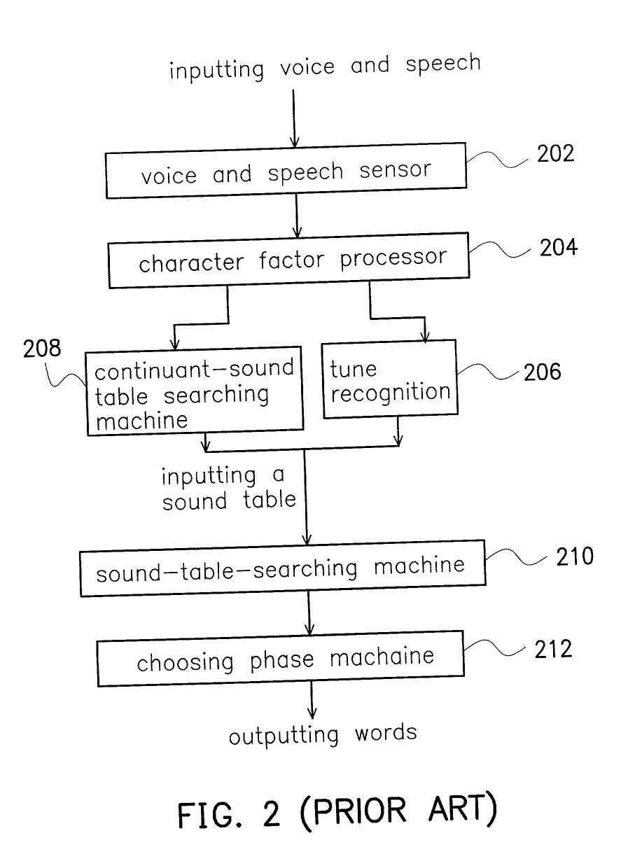

FIG. 3 is a system frame diagram of a method for voice and speech recognition in a preferred embodiment according to the invention;

FIG. 4 is a hardware system frame diagram for operating a method for voice and speech recognition in a preferred embodiment according to the invention; and

FIG. 5 is a flow chart of a method for voice and speech recognition in a preferred embodiment according to the invention.

### DESCRIPTION OF THE PREFERRED EMBODIMENTS

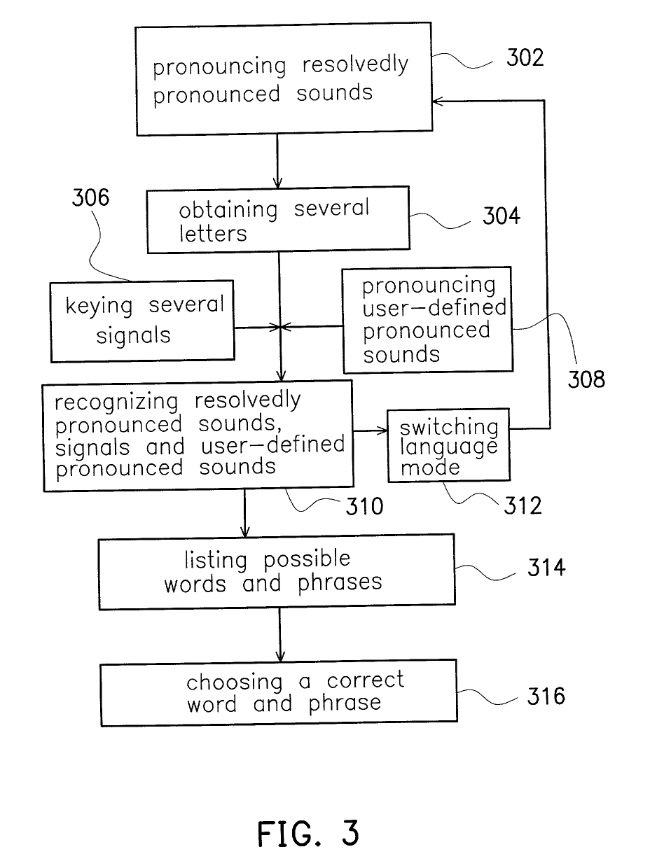

FIG. 3 is a system frame diagram of a method for voice and speech recognition in a preferred embodiment according to the invention.

The method for voice and speech recognition provided by the present invention comprises the steps of inputting several resolvedly pronounced sounds expressed by characters, single set tune and single set phrase (step 302) into a computer to obtain letters respective to the pronounced sounds (step 304). Incidentally, the user-defined pronounced sounds are also inputted into the computer (step 308). Thereafter, as shown in step 310, the user-defined pronounced sounds are converted into symbols or operation modes and the letters are recognized to assemble as a single word or a phrase to respectively obtain particular symbols. Notably, those symbols converted from user-defined pronounced sounds can improve the efficiency of the voice and speech recognition. Also, the user-defined pronounced sounds can aid to assemble the recognized characters or syllables into a correct word or phrase. Moreover, if a single set of pronounced sounds can be recognized into several different assembled words or phrases, the computer will list all the possible words and the phrases (step 314). The correct word or phrase is chose from the possible words and phrases list (step 316). Alternatively, when a user-defined pronounced sound means an operation mode such as switching language mode, the computer will receive this code from decoding the user-defined pronounced sound in step 310 and switch to other language mode in step 312. After switching to other language mode, the user can start to input voice and speech from step 302 by using other language.

Furthermore, many names and placenames are set so that picking up a correct word from an abundant lexicon is necessary. Hence, in the present invention, the auto-searching-and-matching lexicon is used to aid the voice and speech recognition to improve the recognition efficiency and correction.

In the voice and speech recognition according to the invention, in order to input a phrase constructed by a first letter and a second letter into a computer, the pronounced sound of the phrase is firstly sectioned into a first set of pronounced sounds and a second set of pronounced sounds respectively indicating the first letter and the second letter. The first set of pronounced sounds and the second set of pronounced sounds are inputted into the computer in sequence. The first set of pronounced sounds are recognized into a first possible group of words and the second set of pronounced sounds are recognized into a second possible group of words. A phrase with correct combination letters respectively picked up from the first possible group and the second possible group is defined by using the auto-searching lexicon and the context matching process. Even if the pronounced sounds of the phrase is sectioned by user definition, the combination of the phrase still can be well defined because of the using of auto-searching lexicon and context matching process.

Incidentally, the method for voice and speech recognition in the present invention can be cooperated with the use of the keyboard. As shown in FIG. 3, several user-defined signals are keyed into the computer (step 306) together with the inputting pronounced sounds (in step 302) and the user-defined pronounced sounds (step 304). Thereafter, as shown in step 310, the user-defined pronounced sounds and the keyed signals are converted into symbols or operation modes and the letters are recognized to assemble as a single word or a phrase to respectively obtain particular symbols. Notably, those symbols converted from user-defined pronounced sounds and keyed signals can improve the efficiency of the voice and speech recognition. Also, the user-defined pronounced sounds can aid to assemble the recognized characters or syllables into a correct word or phrase. Moreover, if a single set of pronounced sounds can be recognized into several different assembled words or phrases, the computer will list all the possible words and the phrases (step 314). The correct word or phrase is chose from the possible words and phrases list (step 316). Alternatively, when a user-defined pronounced sound or a keyed signal means an operation mode such as switching language mode, the computer will receive this code from decoding the user-defined pronounced sound or the keyed signal in step 310 and switch to other language mode in step 312. After switching to other language mode, the user can start to input voice and speech from step 302 by using other language.

When a word is attempted to be inputted into a computer, the pronounced sound of the word is sectioned into a first pronounced sound, a second pronounced sound and a tune. During the first and the second pronounced sounds are inputted into the computer, the tune can be keyed into the computer at the same time. By keying tune into computer through the user-defined pads on the keyboard, the tune of a word or a phrase can be clearly recognized by computer and accuracy of the voice and speech recognition is improved.

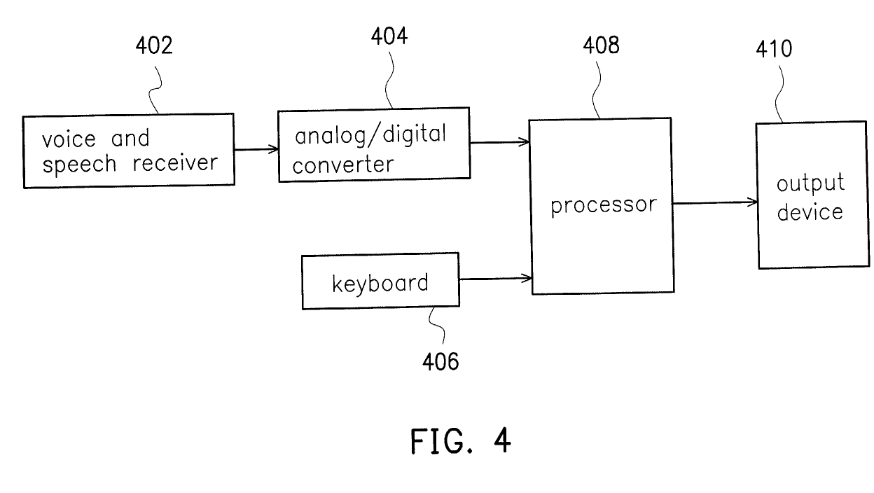

FIG. 4 is a hardware system frame diagram for operating a method for voice and speech recognition in a preferred embodiment according to the invention.

As shown in FIG. 4, the pronounced sounds of a word or a phrase are sectioned into several resolvedly pronounced sounds. The resolvedly pronounced sounds and user-defined pronounced sounds are received by a voice and speech receiver 402 such as microphone. The sounds are converted into digital signals by analog/digital converter 404. The digital signals and keyed signals inputted from keyboard 406 are transferred into a processor 408 such as a computer or a micro controller. After the digital signals and keyed signals are transferred into the processor, a possible phrase and word table is developed and the correct word and phrase according to the pronounced sounds is picked up from the table. The correct word and phrase is shown by output device 410 such as a personal digital assistant (PDA), an information appliance (IA) or a cellular phone. Typically, the way to key words or phrases into a cellular phone is very complex and the handwriting method to input words or phrases into a PDA is also inconvenience. In order to promote the user's convenience, it is necessary to use voice and speech recognition to input words or phrases into those devices.

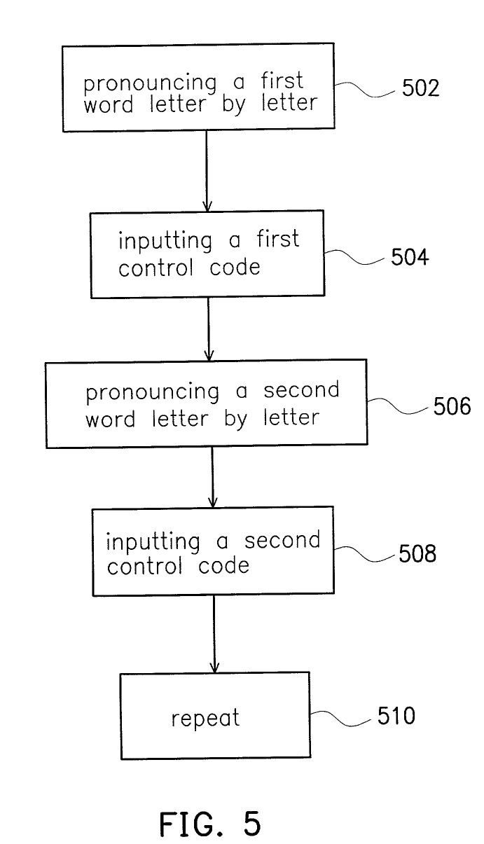

FIG. 5 is a flow chart of a method for voice and speech recognition in a preferred embodiment according to the invention.

As shown in FIG. 5, a first word is pronounced in sectioned sounds in sequence (step 502). A first control code meaning a first space or a first symbol is inputted into a computer (step 504). A second word is pronounced in sectioned sounds in sequence (step 506). A second control code meaning a second space or a second symbol is inputted into the computer (step 508). In step 510, the serial steps from step 502 to step 508 are subsequently repeated until a whole sentence is completely inputted into a computer. Notably, the first control code and the second control code is inputted into computer through pronouncing user-defined pronounced sounds or pressing user-define key on a keyboard.

Moreover, although conventional voice and speech recognition can achieve 80% accuracy, similar pronounced sounds could confuse the recognition process and result in showing incorrect words with similar pronounced sounds. Besides, when mis-recognition occurs, it is necessary to use keying method to delete or further correct the incorrect words. However, the commercial communicative products do not possess enough letter pads. No doubt, it is very inconvenience to use the conventional inputting system. Taking English as an example, a word or a phrase is pronounced in letter by letter and the space between words or phrase and symbol are pronounced by user-defined pronounced sounds or keyed by pressing user-defined pads on a keyboard. Hence, the voice and speech can be accurately recognized through letter by letter and the letters can be accurately assembled into a correct word or a phrase. Since every letter is pronounced uniquely and the word or the phrase is pronounced in letter by letter, the recognition accuracy can be promoted to 100%. It should be noticed that any language which can be expressed by spelling letters or sounds and tunes is suitable to be inputted into a computer through the method of voice and speech recognition according to the present invention.

In the present invention, the auto-searching lexicon and user-defined pronounced sounds and keyed signals are used to aid the recognition of set names and set placenames and to assemble letters into a correct word or phrase. Furthermore, a user-defined pronounced sound can be also set to a switch mode function signal to switch the language-inputting mode.

Altogether, the present invention possesses the following advantages:

1. In the present invention, voice and speech are pronounced in letter by letter or in single sound by single sound. The processor only need to recognize unique sounds and assemble the recognized letters, sounds or tunes into a word or a phrase. It is unnecessary to use complexly recognition procedure as conventional recognition process. Therefore, the recognition time is short.

2. In the present invention, the sounds needed to be recognized at the same moment are few so that it is unnecessary to use a processor with a powerful operation ability.

3. In the present invention, the sounds needed to be recognized at the same moment are few so that the auto-correction and the auto-learning functions of the processor can be efficiently utilized.

Because of the advantages described above, the recognition accuracy is greatly improved. In contrast to the invention, the rate of inputting a whole sentence is relatively high by using the conventional voice and speech recognition but it takes much more time to modify the incorrect words when mis-recognition occurs. According to the invention, the voice and speech is pronounced in spelling letters, sounds or tunes so that the recognition accuracy is high. When the voice and speech recognition is applied on IA products to input short messages, the convenience and accuracy can be greatly improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of voice and speech recognition, comprising the steps of:
inputting a plurality of sectioned pronounced sounds, wherein the sectioned sounds are expressed by characters, single set tune and single set phrase;
obtaining a plurality of letters respective to the sectioned pronounced sounds;
inputting a plurality of user-defined pronounced sounds to respectively input a plurality of symbols;
recognizing the sectioned pronounced sounds and the user-defined pronounced sounds;
combining the letters to obtain a plurality of possible words and a plurality of switching language mode operations; and
choosing at least a correct word.

2. The method of claim 1, when the switching language mode operations are performed, the voice and speech recognition process is repeated from the step of inputting a plurality of sectioned pronounced sounds in foreign language.

3. The method of claim 1, wherein the device used in the method comprises: a voice and speech receiver, an analog/digital converter, a processor and an output device.

4. The method of claim 1, wherein an auto-searching lexicon is used to aid the recognition of a plurality of set placenames and set names.

5. The method of claim 1, wherein the user-defined pronounced sounds can improve the recognition efficiency.

6. The method of claim 5, wherein the user-defined pronounced sounds are used to assemble a plurality of recognized letters or syllables into the correct word.

7. The method of claim 6, wherein the user-defined pronounced sound is used to switch language mode.

8. A method of voice and speech recognition, comprising the steps of:
inputting a plurality of sectioned pronounced sounds, wherein the sectioned sounds are expressed by characters, single set tune and single set phrase;
obtaining a plurality of letters respective to the sectioned pronounced sounds;
inputting a plurality of user-defined pronounced sounds to respectively input a plurality of symbols;
keying a plurality of signals;
recognizing the sectioned pronounced sounds, the user-defined pronounced sounds and keyed signals;
combining the letters to obtain a plurality of possible words and a plurality of switching language mode operations; and
choosing at least a correct word.

9. The method of claim 8, wherein when the switching language mode operations are performed, the voice and speech recognition process is repeated from the step of inputting a plurality of sectioned pronounced sounds in foreign language.

10. The method of claim 8, wherein the device used in the method comprises: a voice and speech receiver, an analog/digital converter, a processor and an output device.

11. The method of claim 8, wherein an auto-searching lexicon is used to aid the recognition of a plurality of set placenames and set names.

12. The method of claim 8, wherein the user-defined pronounced sounds can improve the recognition efficiency.

13. The method of claim 12, wherein the user-defined pronounced sounds are used to assemble a plurality of recognized letters or syllables into the correct word.

14. The method of claim 13, wherein either the user-defined pronounced sounds or the keyed signals are used to switch language mode.

15. A method of voice and speech recognition, comprising the steps of:
pronouncing a first word letter by letter;
inputting a first control code expressing either a first space or a first symbol;
pronouncing a second word letter by letter;
inputting a second control code expressing either a second space or a second symbol; and
repeating steps describing above until a sentence is completely inputted.

16. The method of claim 15, wherein the first and the second control codes are inputted by either a user-defined pronounced sounds or pressing a pad on a keyboard.
